(19) United States
(12) Patent Application Publication
(10) Pub. No.: US 2016/0259132 A1
(43) Pub. Date: Sep. 8, 2016

(54) OPTICAL CONNECTOR AND ARRANGEMENT HAVING ONE OR MORE TRANSMISSION SURFACES AND A SURFACE WIPER

(71) Applicant: Tyco Electronics Corporation, Berwyn, PA (US)

(72) Inventors: Tao Ling, Harrisburg, PA (US); David D. Erdman, Hummelstown, PA (US)

(21) Appl. No.: 14/635,726

(22) Filed: Mar. 2, 2015

(51) Int. Cl. G02B 6/38

(52) U.S. Cl. CPC G02B 6/3866; G02B 6/3853; G02B 6/3822

(57) ABSTRACT

Optical connector includes a ferrule body having a side face. The optical connector also includes a ferrule lens that is coupled to the ferrule body and positioned along the side face. The ferrule lens is configured to align with a lens of a communication device for communicating optical signals therebetween. The optical connector also includes a surface wiper that is coupled to and extends away from the side face. The surface wiper has a height relative to the side face that is greater than a height of the ferrule lens. The surface wiper is configured to at least one of flex or compress when engaging the lens of the communication device during a side-mating operation.

### BACKGROUND

The subject matter herein relates generally to optical connectors having exposed surfaces through which optical signals propagate.

Optical communication may have advantages over electrical communication in certain applications. Increasingly, both large communication systems and small devices, such as consumer devices, are using optical pathways to transmit data signals through the system or device. The optical pathways may include optical fibers, lenses, and/or other material that permits light to propagate therethrough. When two optical connectors are mated, the optical components (e.g., lenses or fibers) are aligned with each other so that light emitting from one component is received by the other component.

At least some known optical connectors include a ferrule body that optically connects a number of optical fibers to corresponding optical surfaces, such as lenses of a lens array. For example, the ferrule body may include a plurality of channels that each receive and orient a corresponding optical fiber so that the optical fiber is aligned with a corresponding lens of the lens array. The ferrule body may then be positioned adjacent to another optical connector. For instance, each lens of the ferrule body may be aligned with another lens and/or optical fiber of the other optical connector. Optical connectors may be mated with each other in various manners. For some types of optical connectors, the lenses face in the direction of insertion. For example, the lenses may be positioned along a side face of a pluggable optical connector. In other types of optical connectors, however, the lenses may face in a direction that is perpendicular to the insertion direction or perpendicular to the optical fibers.

One challenge that is often confronted by optical connectors is that dust or other debris may exist along the optical surfaces and negatively affect optical transmission. The debris is typically removed using a separate cleaning mechanism. For example, prior to mating the optical connectors, a technician may clean each lens array using a tool. Such a cleaning process could be time-consuming and labor-intensive, which could be expensive.

Accordingly, a need exists for alternative mechanisms or methods of cleaning one or more optical surfaces of an optical connector.

### BRIEF DESCRIPTION

In an embodiment, an optical connector is provided that includes a ferrule body having a side face. The optical connector also includes a transmission surface positioned along the side face. The transmission surface is configured to align with a device surface of a communication device for communicating optical signals therebetween. The optical connector also includes a surface wiper coupled to and extending away from the side face. The surface wiper has a height relative to the side face. The surface wiper is configured to at least one of flex or compress when engaging the device surface of the communication device during a side-mating operation.

In an embodiment, an optical connector is provided that includes a ferrule body having a side face. The optical connector also includes a ferrule lens that is coupled to the ferrule body and positioned along the side face. The ferrule lens is configured to align with a lens of a communication device for communicating optical signals therebetween. The optical connector also includes a surface wiper that is coupled to and extends away from the side face. The surface wiper has a height relative to the side face that is greater than a height of the ferrule lens. The surface wiper is configured to at least one of flex or compress when engaging the lens of the communication device during a side-mating operation.

In an embodiment, an optical arrangement is provided that includes an optical connector having a ferrule body having a side face and a transmission surface that is positioned along the side face. The transmission surface faces in a first direction along a signal axis. The optical arrangement also includes a communication device that has an optical module having a side face and a transmission surface that is positioned along the side face of the optical module. The transmission surface of the communication device faces in a second direction along the signal axis that is opposite the first direction. The optical arrangement also includes a surface wiper that is coupled to the side face of the ferrule body or the side face of the optical module. The optical connector and the communication device are configured to mate with each other during a side-mating operation in which the side faces of the ferrule body and the optical module move parallel to each other along a mating axis that is perpendicular to the signal axis. The surface wiper is configured to wipe the transmission surface of the opposing side face during the side-mating operation.

In an embodiment, an optical arrangement is provided that includes an optical connector having a ferrule body with a side face and a lens that is coupled to the ferrule body and positioned along the side face. The lens faces in a first direction along a signal axis. The optical arrangement also includes a communication device having an optical module with a side face and a lens that is coupled to the optical module and positioned along the side face of the optical module. The lens of the communication device faces in a second direction along the signal axis that is opposite the first direction. The optical arrangement also includes a surface wiper coupled to the side face of the ferrule body or the side face of the optical module. The optical connector and the communication device are configured to mate with each other during a side-mating operation in which the side faces of the ferrule body and the optical module move parallel to each other along a mating axis that is perpendicular to the signal axis. The surface wiper is configured to wipe the lens of the opposing side face during the side-mating operation.

### BRIEF DESCRIPTION OF THE DRAWINGS

FIG. 1 is a perspective view of an optical/electrical (OE) cable assembly formed in accordance with an embodiment.

FIG. 2 is a perspective view of a communication device formed in accordance with an embodiment having an optical interface.

FIG. 3 is a side cross-sectional view of an optical arrangement formed in accordance with an embodiment.

FIG. 4 is an enlarged side cross-sectional view of the optical arrangement during a side-mating operation.

FIG. 5 is a side cross-sectional view of an optical arrangement formed in accordance with an embodiment.

FIG. 6 is a side cross-sectional view of an optical arrangement formed in accordance with an embodiment.

FIG. 7 is an enlarged perspective view of a lens array that may be used by one or more embodiments.

FIG. 8 is a side cross-sectional view of an optical arrangement formed in accordance with an embodiment.

FIG. 9 is a side cross-sectional view of an optical arrangement formed in accordance with an embodiment.

### DETAILED DESCRIPTION

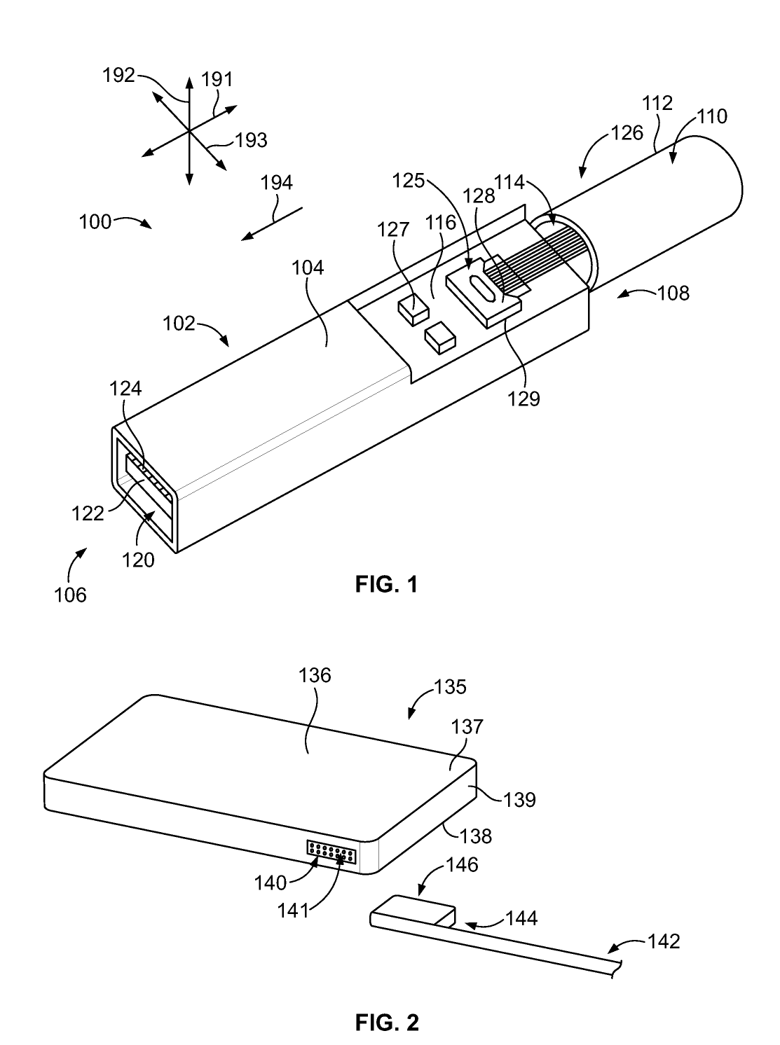

FIG. 1 is a partially exposed perspective view of an optical/electrical (OE) cable assembly 100 in accordance with an embodiment. The cable assembly 100 includes a pluggable connector 102 having an elongated connector housing 104 that extends between a mating end 106 and a loading end 108. The pluggable connector 102 may also be referred to as a communication device. The pluggable connector 102 also includes a communication cable 110 having a cable jacket 112 and a bundle of optical fibers 114 that are surrounded by the cable jacket 112. The communication cable 110 is coupled to the loading end 108 of the connector housing 104. In FIG. 1, a portion of the connector housing 104 proximate to the loading end 108 has been removed to reveal an interior of the pluggable connector 102 and a terminating end of the communication cable 110.

In some embodiments, the pluggable connector 102 is a pluggable input/output (I/O) module in which at least a portion of the pluggable I/O module that is configured to be compliant with certain industry standards, such as, but not limited to, the small-form factor pluggable (SFP) standard, enhanced SFP (SFP+) standard, quad SFP (QSFP) standard, C form-factor pluggable (CFP) standard, and 10 Gigabit SFP standard, which is often referred to as the XFP standard. In some embodiments, the pluggable connector may be configured to be compliant with small form factor (SFF), such as SFF-8644 and SFF-8449 HD. In some embodiments, the cable assemblies described herein may be high-speed cable assemblies that are capable of transmitting data at a rate of at least about four (4) gigabits per second (Gbps), at least about 10 Gbps, at least about 20 Gbps, at least about 40 Gbps, or more. Although the cable assemblies may be high-speed cable assemblies in some embodiments, the cable assemblies may transmit at slower transmission speeds or data rates in other embodiments.

Also shown, the pluggable connector 102 includes a circuit board 116 that is disposed within a housing cavity 120 defined by the connector housing 104. The circuit board 116 includes a mating edge 122 having an array of electrical contacts 124 disposed therealong. The mating edge 122 is configured to engage an electrical connector (not shown) to establish an electrical connection.

The cable assembly 100 also includes an optical connector 125 that is mounted to the circuit board 116. The optical connector 125 is coupled to the optical fibers 114 and is configured to communicatively couple the optical fibers 114 to a signal converter or another optical component of the pluggable connector 102. The optical fibers 114 may transmit optical signals that are received and converted by the pluggable connector 102 and/or the optical fibers 114 may receive optical signals that are transmitted by the pluggable connector 102. In some embodiments, the optical connector 125 and the communication cable 110 may form an optical sub-assembly 126.

The cable assembly 100 is oriented with respect to mutually perpendicular axes 191, 192, 193, including a mating axis 191, a mounting axis 192, and a lateral axis 193. As shown, portions of the optical fibers 114 extend generally parallel to the circuit board 116 and to the mating axis 191 when near the optical connector 125. The optical connector 125 is configured to re-direct optical signals that propagate through an interface between the optical connector 125 and the circuit board 116. For example, the optical connector 125 is configured to re-direct optical signals that are propagating through the optical fibers 114 and into the circuit board 116 and/or re-direct optical signals that are received from the circuit board 116 into the optical connector 125. More specifically, the optical connector 125 is configured to direct optical signals from the optical fibers 114 in a direction perpendicular to the circuit board 116 and/or receive optical signals from the circuit board 116 in a direction that is perpendicular to the circuit board 116.

Accordingly, the optical connector 125 has an orthogonal relationship with the circuit board 116 such that the optical signals are re-directed (e.g., by about 90°). The optical connector 125 includes a ferrule or optical module 128 that has a mounting side 129 that faces the circuit board 116. In FIG. 1, the pluggable connector 102 is fully assembled with the optical connector 125 in a seated position relative to the circuit board 116 such that optical signals may be communicated between the optical connector 125 and the circuit board 116. In some embodiments, the optical connector 125 (or the ferrule 128) undergoes a side-mating operation in which the mounting side 129 is moved along the circuit board 116 in a loading direction 194 along the mating axis 191 as the mounting side 129 faces the circuit board 116. In the illustrated embodiment, the loading direction 194 is from the loading end 108 to the mating end 106. In other embodiments, however, the loading direction 194 may be in any direction that is parallel to the circuit board 116 or a plane defined by the axes 191, 193.

Also shown in FIG. 1, the pluggable connector 102 may include one or more signal-processing elements 127. The signal-processing elements 127 are represented generically as boxes in FIG. 1, but may include various circuitry that may be mounted to the circuit board 116 within the connector housing 104. The signal-processing elements 127 are configured to process or modify electrical signals in a predetermined manner. By way of example, the signal-processing elements 127 may include one or more integrated circuits, capacitors, inductors, or resistors.

FIG. 2 is a perspective view of a communication device 135 in accordance with one embodiment. The communication device 135 may be, for example, a smart phone, an electronic reader (e-reader), or other handheld consumer device. As shown in FIG. 2, the communication device 135 includes a device body 136 having a top and bottom side 137, 138, respectively, with a body edge 139 extending between the top and bottom sides 137 and 138. The communication device 135 may include a communication port (or mating interface) 140 that is configured to mate with an optical connector 144 of an optical cable assembly 142. The communication port 140 may include an array of transmission surfaces 141 through which optical signals propagate. In FIG. 2, the optical surfaces 141 are lenses that are shaped to direct the optical signals (e.g., light signals) in a predetermined manner. The lenses 141 are configured to be aligned with corresponding transmission surfaces (e.g., other lenses) (not shown) in the optical connector 144. The transmission surfaces of the optical connector 144 may be arranged along a mounting side 146 of the optical connector 144. Similar to the optical connector 125 (FIG. 1), the optical connector 144 is configured to mate with the communication device 135 during a side-mating operation.

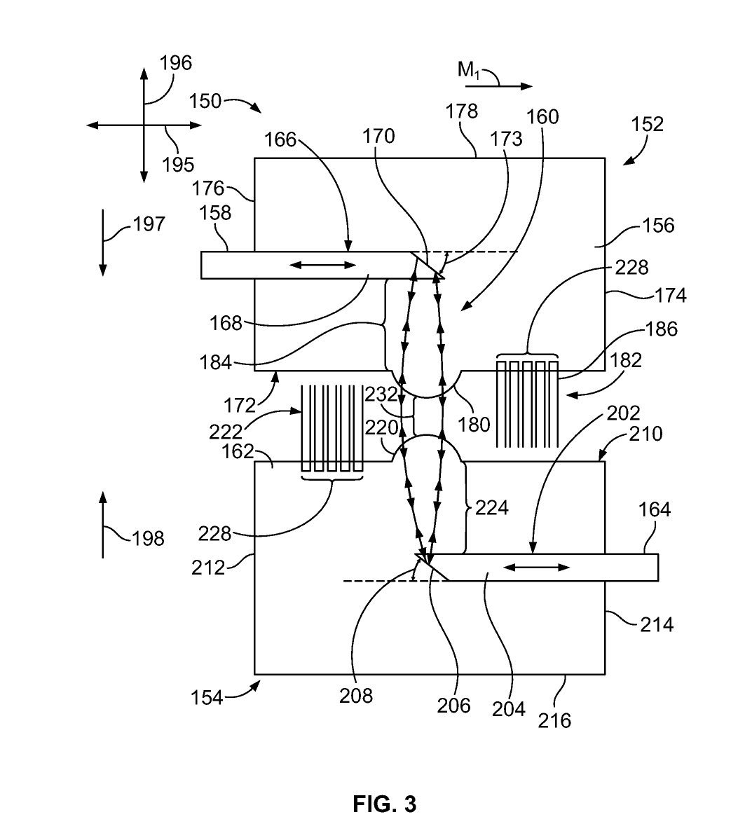

FIG. 3 is a side cross-sectional view of an optical arrangement 150. In an exemplary embodiment, reference number 152 refers to a portion of an optical connector and reference number 154 refers to a portion of a communication device, which are hereinafter referred to as the optical connector 152 and the communication device 154. In other embodiments, however, reference number 152 may refer to a communication device and reference number 154 may refer to an optical connector. In the illustrated embodiment, the optical connector 152 is movable with respect to the communication device 154 along a mating axis 195. In other embodiments, however, the communication device 154 may be movable with respect to the optical connector 152. The optical connector 152 may be, for example, the optical connector 125 (FIG. 1) or the optical connector 144 (FIG. 2). As used herein, the term “communication device” is not intended to be limiting and includes any component or element capable of transmitting/receiving signals through an optical interface. The communication device 154 may be, for example, the pluggable connector 102 (FIG. 1) or a circuit board, such as the circuit board 116 (FIG. 1). The communication device 154 may also be, for example, the communication device 135 (FIG. 2). Also shown, the optical arrangement 150 is positioned relative to a signal axis 196 that is perpendicular to the mating axis 195.

The optical connector 152 includes a ferrule or optical module 156 and at least one optical fiber 158 that is coupled to the ferrule body 156. Although not shown, the optical connector 152 may include other components. For example, the optical connector 152 may include one or more housing parts (not shown) that at least partially surround the ferrule body 156 and/or the optical fiber 158. In the illustrated embodiment, the ferrule body 156 couples to only a single optical fiber 158. In other embodiments, however, the ferrule body 156 may couple to two or more of the optical fibers 158. For example, the ferrule body 156 may couple to at least 2, 4, 8, 12, 16, 32, or 64 optical fibers 158. The ferrule body 156 and each optical fiber 158 may form an optical path for directing data signals 160 in the form of light (hereinafter referred to as optical signals 160). The optical signals are shown as transmitting in both directions. In some embodiments, however, a signal path may be dedicated to transmitting the optical signals 160 in only one direction.

The communication device 154 includes an optical module 162 that is configured to interface with the ferrule body 156 such that the optical signals 160 may be transmitted therebetween along the signal axis 196. The communication device 154 also includes at least one optical fiber 164. The optical fiber 158 is communicatively coupled to the optical fiber 164 such that optical signals 160 propagating through the optical fiber 158 also propagate through the corresponding optical fiber 164. As shown, the optical signals 160 also propagate through a portion of the ferrule body 156 and a portion of the optical module 162. Collectively, a single signal pathway is formed by the optical fiber 158, the ferrule body 156, the optical module 162, and the optical fiber 164. In alternative embodiments, the communication device 154 does not include an optical module 162 or an optical fiber 164. For example, the communication device 154 may include a circuit board (not shown) having a vertical cavity surface-emitting laser (VCSEL) (not shown) that is positioned to emit the optical signals into the ferrule body 156.

The ferrule body 156 is configured to hold the optical fiber 158 in a designated position such that the optical signals 160 may propagate through at least a portion of the ferrule body 156. Accordingly, the ferrule body 156 may be at least partially formed from an optically transparent material, such as glass or a polymer material. For example, the ferrule body 156 may be molded to include a fiber cavity 166 that is sized and shaped to receive an end segment 168 of the optical fiber 158. As shown, the optical fiber 158 includes an angled end surface 170. The angled end surface 170 forms a non-orthogonal angle 173 with respect to a direction of propagation through the optical fiber 158 or with respect to the mating axis 195. In the illustrated embodiment, the non-orthogonal angle 173 is 45° such that the optical signals are reflected in a direction that is substantially perpendicular to an incident direction. In some embodiments, the ferrule body 156 and/or a mirror coated on the angled end surface 170 may facilitate the reflection of the optical signals. For example, a material of the ferrule body 156 adjacent to the angled end surface 170 may have a refractive index lower than the refractive index of the optical fiber 158 that facilitates the desired reflection of the optical signals 160.

The ferrule body 156 includes a side face 172 that faces the communication device 154. The side face 172 extends between a front or leading side 174 and a back or trailing side 176 of the ferrule body 156. In the illustrated embodiment, the front side 174 and the back side 176 have planar surfaces that extend perpendicular to the mating axis 195. The ferrule body 156 also includes a top side 178 that is located opposite the side face 172 and extends between the front and back sides 174, 176. The top side 178 may also be defined by a planar surface. In other embodiments, however, one or more of the front side 174, the back side 176, and the top side 178 may have non-planar surfaces. In the illustrated embodiment, the entire ferrule body 156 shown in FIG. 3 is shaped from a common optically-transparent material. In other embodiments, however, one or more portions may be formed from a different material and/or a material that is not optically-transparent.

Also shown in FIG. 3, the ferrule body 156 includes transmission surface 180. The transmission surface 180 is a surface through which optical signals propagate. In the illustrated embodiment, the transmission surface 180 is shaped to form a convex ferrule lens. As such, the transmission surface 180 is hereinafter referred to as a ferrule lens 180. It should be understood, however, that the transmission surface 180 may be planar or concave in other embodiments. The ferrule lens 180 and a surface wiper 182 are positioned along the side face 172. In other embodiments, the ferrule body 156 may include an optical array having a plurality of the transmission surfaces, such as a plurality of the ferrule lenses 180. The ferrule lens 180 (or lens array) faces in a first direction 197 along the signal axis 196. As shown, the optical signals 160 propagate along a path region 184 between the ferrule lens 180 and the angled end surface 170. The path region 184 represents a portion of the ferrule body 156 that the optical signals 160 propagate through. In some embodiments, the path region 184 is not structurally distinct from nearby regions of the ferrule body 156. In other embodiments, however, the path region 184 may be structurally distinct. For example, the path region 184 may have a different refractive index and/or different material than other regions that surround the path region 184. In some cases, the path region 184 comprises a cavity or channel that is defined by the ferrule body 156. In such embodiments, the ferrule lens 180 may be attached to the ferrule body 156 and positioned within the path of the optical signals 160.

The communication device 154 may have a similar configuration as the optical connector 152. In the illustrated embodiment, the communication device 154 is identical to the optical connector 152. For example, the optical module 162 may be identical to the ferrule body 156 and is configured to hold the optical fiber 164 in a designated position such that the optical signals 160 may propagate through at least a portion of the optical module 162. Accordingly, the optical module 162 may be at least partially formed from an optically transparent material. The optical module 162 may include a fiber cavity 202 that is sized and shaped to receive an end segment 204 of the optical fiber 164.

The optical fiber 164 may also include an angled end surface 206 that is configured to direct the optical signals 160 in a designated direction. The angled end surface 206 forms a non-orthogonal angle 208 with respect to the propagating direction through the optical fiber 164. In the illustrated embodiment, the non-orthogonal angle 208 is 45° such that the optical signals are directed in a direction that is substantially perpendicular to the optical fiber 164 (or the mating axis 195). In some embodiments, the optical module 162 and/or a resin coated on the angled end surface 206 may facilitate the reflection of the optical signals. For example, a material of the optical module 162 that is adjacent to the angled end surface 206 may have a refractive index relative to the refractive index of the optical fiber 164 that facilitates the desired reflection of the optical signals 160.

The optical module 162 includes a side face 210 that faces the ferrule body 156. The side face 210 extends between a front or leading side 212 and a back or trailing side 214 of the optical module 162. In the illustrated embodiment, the front side 212 and the back side 214 have planar surfaces that extend perpendicular to the mating axis 195. The optical module 162 also includes a bottom side 216 that is located opposite the side face 210 and extends between the front and back sides 212, 214. The bottom side 216 may also be defined by a planar surface. In other embodiments, however, one or more of the front side 212, the back side 214, and the bottom side 216 may have non-planar surfaces. In the illustrated embodiment, the entire optical module 162 shown in FIG. 3 is shaped from a common optically transparent material. In other embodiments, however, one or more portions may be formed from a different material and/or a material that is not optically transparent.

Also shown in FIG. 3, the optical module 162 includes a transmission surface 220 and a surface wiper 222 positioned along the side face 210. The transmission surface is shaped to form a convex lens that is hereinafter referred to as a device lens 220. It should be understood, however, that the transmission surface may be planar or concave in other embodiments. The device lens 220 faces in a second direction 198 along the signal axis 196. The second direction 198 is opposite the first direction 197. The device lens 220 is a convex lens, but a concave lens may be used in other embodiments. As shown, the optical signals 160 propagate along a path region 224 between the device lens 220 and the angled end surface 206. The path region 224 represents a portion of the optical module 162 that the optical signals 160 propagate through. In some embodiments, the path region 224 is not structurally distinct from nearby regions of the optical module 162. In other embodiments, the path region 224 may be structurally distinct. For example, the path region 224 may have a different refractive index than other regions that surround the path region 224. In some cases, the path region 224 comprises a cavity or channel that is defined by the optical module 162. In such embodiments, the device lens 220 may be attached to the optical module 162 and positioned within the path of the optical signals 160.

The surface wipers 182, 222 are positioned along the side faces 172, 210, respectively, and spaced apart from each other. In the illustrated embodiment, the surface wiper 182 is positioned between the front side 174 and the ferrule lens 180, and the surface wiper 222 is positioned between the front side 212 and the device lens 220. Each of the surface wipers 182, 222 may comprise one or more flexible or compressible materials. In the illustrated embodiment, the surface wipers 182, 222 are identical in structure and composition, but may have different structures and/or different materials in other embodiments.

Each of the surface wipers 182, 222 may include one or more elements of a flexible or compressible material(s). For example, in the illustrated embodiment, the surface wipers 182, 222 comprise a plurality of flexible bristles or strands 186. In other embodiments, the surface wipers 182, 222 may comprise a compressible material, such as foam or a sponge. As described herein, the surface wiper 182 is configured to slide along and engage the device lens 220 of the communication device 154 during a side-mating operation. The surface wiper 222 is configured to slide along and engage the ferrule lens 180 of the optical connector 152 during the side-mating operation. In alternative embodiments, however, only one of the optical connector 152 or the communication device 154 includes a surface wiper.

In an exemplary embodiment, the surface wipers 182, 222 are molded with the ferrule body 156 and the optical module 162, respectively. For example, a base portion 228 of the corresponding surface wiper may be disposed within a mold cavity prior to the material of the corresponding body flowing into the mold cavity. The base portion 228 may be coupled to and/or formed with the ferrule body 156 or the optical module 162. The base portion 228 has a fixed position with respect to the corresponding ferrule body 156 or the corresponding optical module 162. Alternatively, the base portion 228 may be coupled to the corresponding ferrule body or optical module using an adhesive. In yet another alternative embodiment, the surface wiper may include a block of material (not shown) as a wiper base and the bristles 186 (shown in FIG. 3) attached to the wiper base. The wiper base may be separate or discrete element that forms an interference fit (e.g., snap tit) with the corresponding ferrule body or optical module.

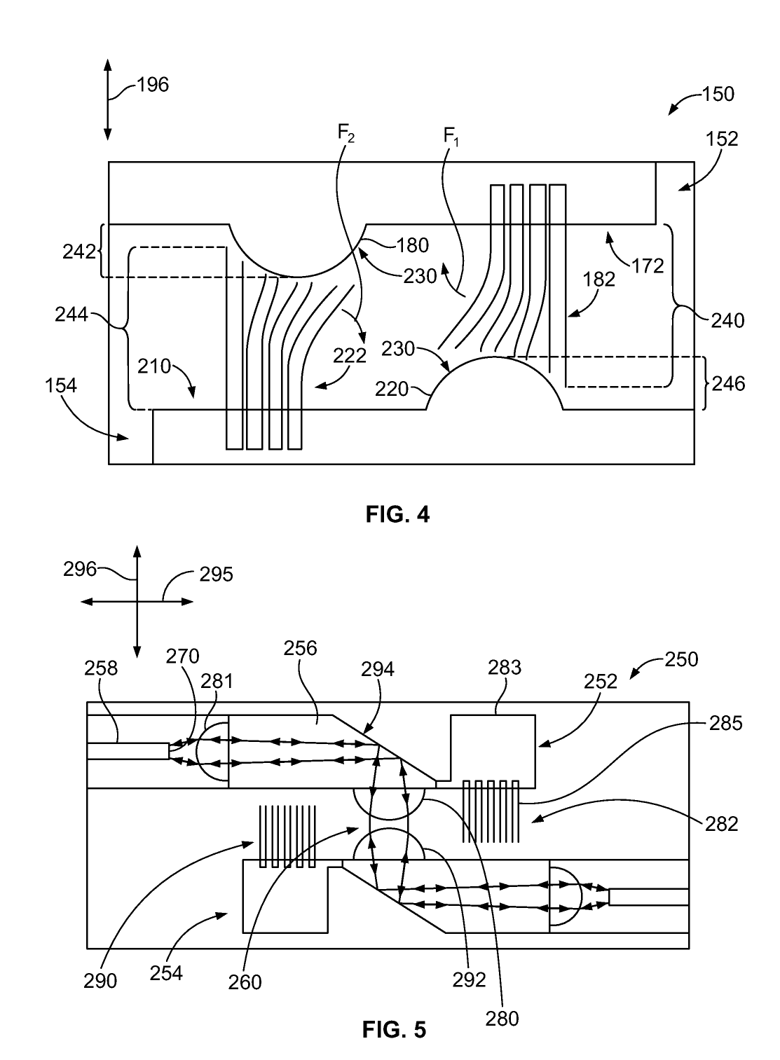

FIG. 4 illustrates the optical arrangement 150 during a side-mating operation. In some embodiments, the optical connector 152 may be moved relative to the communication device 154 during the side-mating operation. In other embodiments, the communication device 154 is moved relative to the optical connector 152. In some embodiments, each of the communication device 154 and the optical connector 152 may be moved during the side-mating operation.

As shown, the side face 172 and the side face 210 oppose each other during the side-mating operation. The surface wiper 182 extends away from the side face 172 and has a height 240 that is measured relative to the side face 172 along the signal axis 196. The ferrule lens 180 has a height 242 that is measured relative to the side face 172. As shown, the height 240 is greater than the height 242. By way of example, the height 240 may be at most 10 millimeters (mm). In some embodiments, the height 240 may be at most 8 mm or, more specifically, at most 6 mm. In particular embodiments, the height 240 may be at most 5 mm or at most 4 mm. In more particular embodiments, the height 240 may be at most 3 mm or at most 2 mm. In some embodiments, the height 242 is less than one-half (½) the height 240. The surface wiper 222 extends away from the side face 210 and has a height 244 that is measured relative to the side face 210. The device lens 220 has a height 246 that is measured relative to the side face 210. As shown, the height 244 is greater than the height 246. The height 244 may have similar dimensions as the height 240. In some embodiments, the height 246 is less, than one-half (½) the height 244.

Although not shown in FIG. 4, the surface wiper 182 and the surface wiper 222 may engage each other during the side-mating operation and flex or bend to permit each of the surface wipers 182, 222 to clear the other. More specifically, the surface wiper 182 may flex or bend toward the side face 172 (as indicated by the arrow F₁) and the surface wiper 222 may flex or bend toward the side face 210 (as indicated by the arrow F₂) during the side-mating operation.

After the surface wipers 182, 222 clear each other during the side-mating operation, the surface wipers 182, 222 may engage the device lens 220 and the ferrule lens 180, respectively. Each of the device lens 220 and the ferrule lens 180 has a lens surface 230 that includes a curved contour that protrudes away from the respective side face. In the illustrated embodiment, the surface wiper 182, the surface wiper 222, the device lens 220, and the ferrule lens 180 are positioned relative to one another such that the surface wipers 182, 222 respectively engage the device lens 220 and the ferrule lens 180 concurrently or simultaneously. In other embodiments, however, the surface wipers 182, 222 may engage the corresponding lenses during non-overlapping time periods. For example, the surface wiper 182 may engage and wipe the device lens 220 prior to the surface wiper 222 engaging and wiping the ferrule lens 180.

As the surface wiper 182 engages the device lens 220, the surface wiper 182 flexes and/or compresses to allow the device lens 220 to move therethrough while simultaneously wiping the corresponding lens surface 230. As the surface wiper 222 engages the ferrule lens 180, the surface wiper 222 flexes and/or compresses to allow the ferrule lens 180 to move therethrough while simultaneously wiping the corresponding lens surface 230. The surface wipers 182, 222 slide along and wipe the respective device lens 220 and ferrule lens 180 to remove debris, such as dust, oil, contaminants, and the like.

Returning briefly to FIG. 3, after the surface wipers 182, 222 have wiped the respective lens surfaces 230 (FIG. 4), the device lens 220 and the ferrule lens 180 align with each other for communicating the optical signals 160. A signal gap 232 may exist between the device lens 220 and the ferrule lens 180. The signal gap 232 is configured to allow the device lens 220 and the ferrule lens 180 to align with each other without engaging and damaging each other. The signal gap 232 may be configured to reduce the likelihood that the device lens 220 and the ferrule lens 180 engage each other due to tolerances in manufacturing. The signal gap 232 may be, for example, two (2) to five (5) mm. However, the signal gap 232 may be less or greater in other embodiments.

FIG. 5 is a side cross-sectional view of an optical arrangement 250. In an exemplary embodiment, reference number 252 refers to a portion of an optical connector and reference number 254 refers to a portion of a communication device, which are hereinafter referred to as the optical connector 252 and the communication device 254. In other embodiments, however, reference number 252 may refer to a communication device and reference number 254 may refer to an optical connector. In the illustrated embodiment, the optical connector 252 is movable with respect to the communication device 254 along a mating axis 295. In other embodiments, however, the communication device 254 may be movable with respect to the optical connector 252. The optical connector 252 may be, for example, the optical connector 125 (FIG. 1) or the optical connector 144 (FIG. 2). The communication device 254 may be, for example, the pluggable connector 102 (FIG. 1) or, more specifically, the circuit board 116 (FIG. 1). The communication device 154 may also be, for example, the communication device 135 (FIG. 2).

The optical connector 252 may include components and features that are similar to the optical connector 152 (FIG. 3). For example, the optical connector 252 includes a ferrule body 256 that is configured to receive and hold an optical fiber 258 at a designated position. The optical connector 252 also includes first and second ferrule lenses 280, 281. In other embodiments, the first ferrule lens 280 may be, more generally, a transmission surface. The transmission surface may be planar or concave in other embodiments. The first ferrule lens 280 is configured to face and communicate optical signals 260 with the communication device 254. The second ferrule lens 281 is configured to face an end 270 of the optical fiber 258 and communicate the optical signals 260 therebetween.

As shown in FIG. 5, the ferrule body 256 includes an angled surface 294 that is angled with respect to the mating axis 295 and a signal axis 296 that is perpendicular to the mating axis 295. The angled surface 294 may be coated with a resin or other material to form a mirror that reflects the optical signals 260. More specifically, if the optical signals 260 are propagating along the signal axis 296 toward the angled surface 294, the angled surface 294 may reflect the optical signals 260 by about 90° toward the second ferrule lens 281. The second ferrule lens 281 may then direct the optical signals 260 into the optical fiber 258. Alternatively, if the optical signals 260 are propagating along the mating axis 295 toward the angled surface 294, the angled surface 294 may reflect the optical signals 260 by about 90° toward the first ferrule lens 280. The first ferrule lens 280 may then direct the optical signals 260 into a device lens 292 of the communication device 254. In the illustrated embodiment, the device lens 292 is a transmission surface that has been shaped to form a convex lens. In other embodiments, the transmission surface may be planar or concave.

The optical connector 252 may also include a surface wiper 282. The surface wiper 282 is configured to wipe the device lens 292 during a side-mating operation. The surface wiper 282 may be similar or identical to the surface wiper 182 (FIG. 3). The communication device 254 may be similar or identical to the optical connector 252 and is configured to mate with the optical connector 252 during a side-mating operation. For example, the communication device 254 also includes a surface wiper 290. During the side-mating operation, the surface wiper 290 wipes the ferrule lens 280 and the surface wiper 282 wipes the device lens 292.

As shown in FIG. 5, the surface wiper 282 may include a wiper base 283 and a plurality of flexible strands 285 that are coupled to the wiper base 283. The wiper base 283 may be a separate and discrete component that is attached to the ferrule body 256. In other embodiments, the wiper base 283 may be formed with the ferrule body 256 such that the wiper base 283 forms a portion of the ferrule body 256.

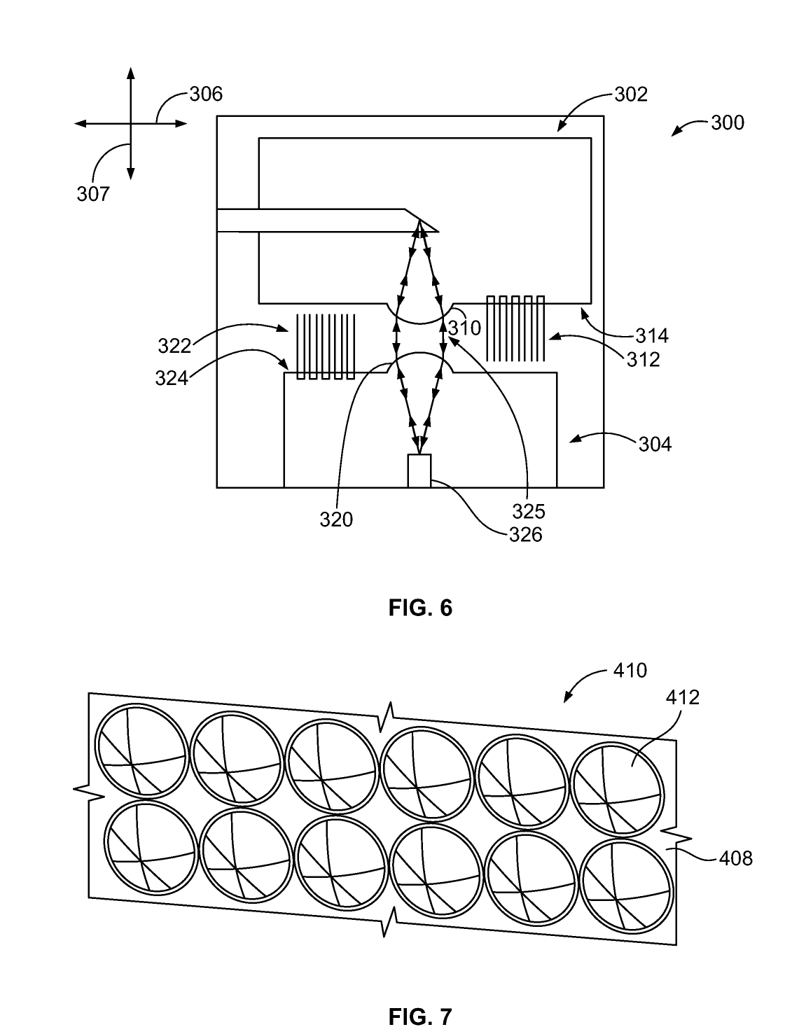

FIG. 6 is a side cross-sectional view of an optical arrangement 300 formed in accordance with an embodiment. The optical arrangement 300 includes a first optical connector 302 and a second optical connector 304. The first and second optical connectors 302, 304 are configured to engage each other during a side-mating operation in which the first optical connector 302 is moved along a mating axis 306. The first and second optical connectors 302, 304 may be similar or identical to the optical connectors and communication devices described herein. For example, the first optical connector 302 includes a ferrule lens 310 and a surface wiper 312 that are positioned along a side face 314 of the first optical connector 302. The second optical connector 304 includes a signal lens 320 and a surface wiper 322 that are positioned along a side face 324 of the second optical connector 304.

During the side-mating operation, the surface wiper 322 may wipe the ferrule lens 310 and the surface wiper 312 may wipe the signal lens 320. When the signal lens 320 and the ferrule lens 310 are aligned as shown in FIG. 6, the signal lens 320 and the ferrule lens 310 may oppose each other and face in opposite directions along a signal axis 307. The signal axis 307 is perpendicular to the mating axis 306. During operation of the optical arrangement 300, optical signals 325 may propagate therebetween along the signal axis 307. In the illustrated embodiment, the second optical connector 304 includes an optical fiber 326 that extends parallel to the signal axis 307. In some embodiments, the side face 324 may constitute a leading end of the second optical connector 304.

FIG. 7 illustrates a portion of an exemplary lens array 410. The lens array 410 may be used with the optical connectors 125, 152, 252 or other communication devices described herein. For such embodiments that include a lens array, embodiments may also include one or more surface wipers. As shown, the lens array 410 includes a plurality of lenses 412 (hereinafter ferrule lenses 412). The ferrule lenses 412 may be similar or identical to the ferrule lenses and device lenses described herein. For example, each of the ferrule lenses 412 is a convex lens that protrudes from the side face 408. In the illustrated embodiment, the lens array 410 include twelve (12) ferrule lenses 412. However, in other embodiments, the lens array 410 may include any number of ferrule lenses 412. By way of example, the lens array 410 may include 2, 4, 8, 12, 16, 32, or 64 ferrule lenses 412. It should be understood that the lens array 410 may include other numbers of ferrule lenses 412, including an odd number of ferrule lenses 412. In an alternative embodiment, the side face 408 may include only a single ferrule lens 412.

The lens array 410 may also be referred to as an optical array. In other embodiments, the optical array 410 may include a plurality of transmission surfaces in which the transmission surfaces are planar or convex.

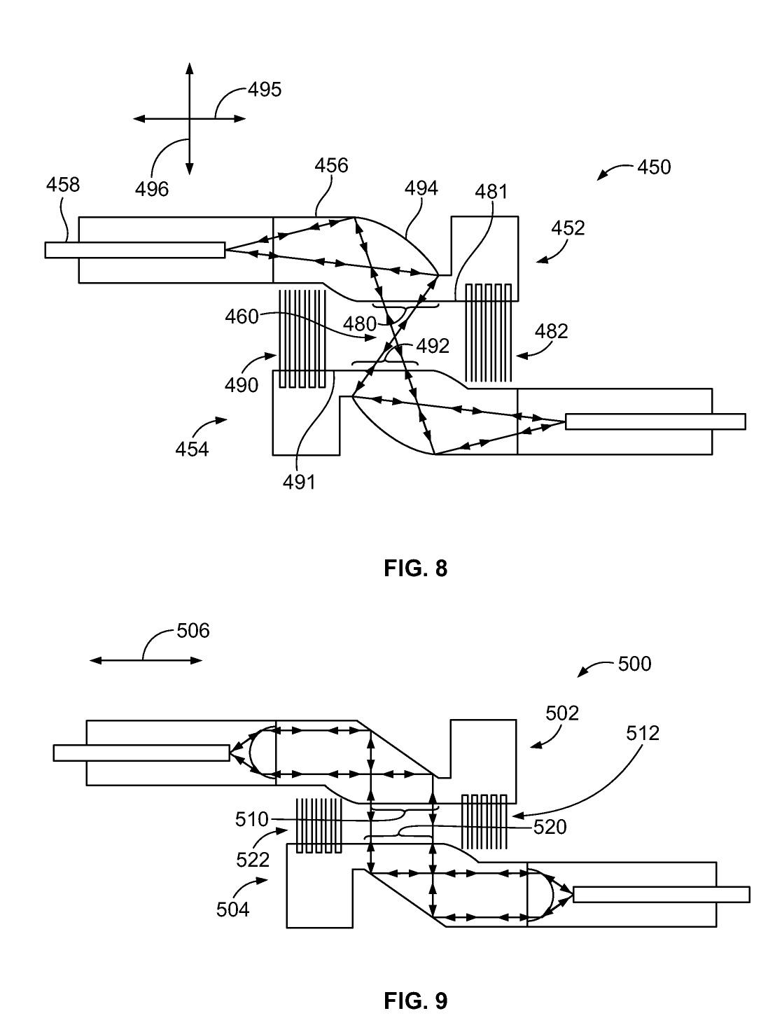

FIG. 8 is a side cross-sectional view of an optical arrangement 450. In an exemplary embodiment, reference number 452 refers to a portion of an optical connector and reference number 454 refers to a portion of a communication device, which are hereinafter referred to as the optical connector 452 and the communication device 454. In the illustrated embodiment, the optical connector 452 is movable with respect to the communication device 454 along a mating axis 495. In other embodiments, however, the communication device 454 may be movable with respect to the optical connector 452. The optical connector 452 may be, for example, the optical connector 125 (FIG. 1) or the optical connector 144 (FIG. 2). The communication device 454 may be, for example, the pluggable connector 102 (FIG. 1) or, more specifically, the circuit board 116 (FIG. 1). The communication device 154 may also be, for example, the communication device 135 (FIG. 2).

The optical connector 452 may include components and features that are similar to the optical connector 152 (FIG. 3). For example, the optical connector 452 includes a ferrule body 456 that is configured to receive and hold an optical fiber 458 at a designated position. The ferrule body 456 is formed (e.g., molded) from an optically transparent material to include a reflecting surface 494. The reflecting surface 494 may be coated with a resin or other material to form a mirror that reflects optical signals 460. More specifically, if the optical signals 460 are propagating along a signal axis 496 toward the reflecting surface 494, the reflecting surface 494 may reflect the optical signals 460 toward and into the optical fiber 458. Alternatively, if the optical signals 460 are propagating along the mating axis 495 toward the reflecting surface 494, the reflecting surface 494 may reflect the optical signals 460 toward a transmission surface 480. The transmission surface 480 may be essentially planar and configured to allow the optical signals 460 to be transmitted therethrough. The transmission surface 480 is a portion of a side face 481 of the ferrule body 456.

The optical connector 452 also includes a surface wiper 482. The surface wiper 482 is configured to wipe a transmission surface 492 of the communication device 454 during a side-mating operation. The surface wiper 482 may be similar or identical to the surface wiper 182 (FIG. 3). The communication device 454 may be similar or identical to the optical connector 452 and is configured to mate with the optical connector 452 during a side-mating operation. For example, the communication device 454 also includes a surface wiper 490 located along a side face 491. The transmission surface 492 is a portion of the side face 491. During the side-mating operation, the surface wiper 490 wipes the transmission surface 480 and the surface wiper 482 wipes the transmission surface 492. As shown in FIG. 8, the transmission surfaces 480, 492 may be essentially planar and extend parallel to one another. In other embodiments, the transmission surfaces 480, 492 may form one or more lenses.

FIG. 9 is a side cross-sectional view of an optical arrangement 500 formed in accordance with an embodiment. The optical arrangement 500 includes a first optical connector 502 and a second optical connector 504. The first and second optical connectors 502, 504 are configured to engage each other during a side-mating operation in which at least one of the first optical connector 502 or the second optical connector 504 is moved along a mating axis 506. The optical arrangement 500 may be identical to the optical arrangement 250 (FIG. 5), except the ferrule lenses 290, 292 (FIG. 5) of the optical arrangement 250 are replaced with planar transmission surfaces 510, 520, respectively. During a side-mating operation, a surface wiper 522 of the second optical connector 504 may wipe the transmission surface 510 and a surface wiper 512 may wipe the transmission surface 520. When the transmissions surfaces 510, 520 are aligned as shown in FIG. 9, the transmissions surfaces 510, 520 oppose each other and extend parallel to each other.

In an embodiment, an optical connector is provided that includes a ferrule body having a side face. The optical connector also includes a transmission surface positioned along the side face. The transmission surface is configured to align with a device surface of a communication device for communicating optical signals therebetween. The optical connector also includes a surface wiper coupled to and extending away from the side face. The surface wiper has a height relative to the side face. The surface wiper is configured to at least one of flex or compress when engaging the device surface of the communication device during a side-mating operation.

In one aspect, the transmission surface is shaped to form a convex ferrule lens. Optionally, the height of the surface wiper is greater than a height of the ferrule lens.

In an embodiment, an optical connector is provided that includes a ferrule body having a side face and a ferrule lens coupled to the ferrule body and positioned along the side face. The ferrule lens is configured to align with a lens of a communication device for communicating optical signals therebetween. The optical connector also includes a surface wiper coupled to and extending away from the side face. The surface wiper has a height relative to the side face that is greater than a height of the ferrule lens. The surface wiper is configured to at least one of flex or compress when engaging the lens of the communication device during a side-mating operation.

In one aspect, the height of the surface wiper is at most four (4) millimeters.

In another aspect, the ferrule body is shaped to include the ferrule lens. The optical signals propagate through the ferrule body during operation of the optical connector.

In another aspect, the optical connector includes an optical fiber having an end segment that is coupled to the ferrule body. Optionally, the optical fiber includes an angled end surface that is configured to reflect the optical signals in a predetermined direction that is generally transverse to the end segment of the optical fiber. Optionally, the ferrule lens faces along a signal axis. The optical fiber extends parallel to the signal axis.

In another aspect, the ferrule body has a leading side and a trailing side that face in opposite directions along a mating axis. The side face extends between the leading and trailing sides along the mating axis. The leading side is configured to lead the optical connector during the side-mating operation. Optionally, the surface wiper is positioned between the leading side and the ferrule lens.

In another aspect, the surface wiper includes a plurality of flexible strands that project away from the side face.

In an embodiment, an optical arrangement is provided that includes an optical connector having a ferrule body having a side face and a transmission surface that is positioned along the side face. The transmission surface faces in a first direction along a signal axis. The optical arrangement also includes a communication device that has an optical module having a side face and a transmission surface that is positioned along the side face of the optical module. The transmission surface of the communication device faces in a second direction along the signal axis that is opposite the first direction. The optical arrangement also includes a surface wiper that is coupled to the side face of the ferrule body or the side face of the optical module. The optical connector and the communication device are configured to mate with each other during a side-mating operation in which the side faces of the ferrule body and the optical module move parallel to each other along a mating axis that is perpendicular to the signal axis. The surface wiper is configured to wipe the transmission surface of the opposing side face during the side-mating operation.

In an embodiment, an optical arrangement is provided that includes an optical connector. The optical connector includes a ferrule body having a side face and a lens that is coupled to the ferrule body and positioned along the side face. The lens faces in a first direction along a signal axis. The optical arrangement also includes a communication device. The communication device has an optical module including a side face and a lens that is coupled to the optical module and positioned along the side face of the optical module. The lens of the communication device faces in a second direction along the signal axis that is opposite the first direction. The optical arrangement also includes a surface wiper coupled to the side face of the ferrule body or the side face of the optical module. The optical connector and the communication device are configured to mate with each other during a side-mating operation in which the side faces of the ferrule body and the optical module move parallel to each other along a mating axis that is perpendicular to the signal axis. The surface wiper is configured to wipe the lens of the opposing side face during the side-mating operation.

In one aspect, the surface wiper is a first surface wiper that is coupled to the side face of the optical connector. The optical arrangement also includes a second surface wiper that is coupled to the side face of the communication device. The first surface wiper is configured to wipe the lens of the communication device, and the second surface wiper is configured to wipe the lens of the optical connector during the side-mating operation.

In another aspect, the first and second surface wipers and the lenses of the optical connector and the communication device are positioned relative to each other such that the first and second surface wipers concurrently engage the corresponding lenses during the side-mating operation.

In another aspect, the height of the surface wiper is at most four (4) millimeters with respect to the side face that the surface wiper is coupled to.

In another aspect, the ferrule body is shaped to include the lens. The optical signals propagate through the ferrule body during operation of the optical connector.

In another aspect, the optical connector includes an optical fiber having an end segment that is coupled to the ferrule body. Optionally, the optical fiber includes an angled end surface that is configured to reflect the optical signals in a predetermined direction that is generally transverse to the segment of the optical fiber. Optionally, the optical fiber extends parallel to the signal axis.

In another aspect, the ferrule body has a leading side and a trailing side that face in opposite directions along a mating axis. The side face extends between the leading and trailing sides along the mating axis. The leading side is configured to lead the optical connector during the side-mating operation.

In another aspect, the surface wiper includes a plurality of flexible strands that project away from the corresponding side face. The surface wiper is configured to at least one of flex or compress when engaging the corresponding lens during the side-mating operation.

In another aspect, the surface wiper is coupled to the side face of the optical connector and has a height relative to the side face of the optical connector that is greater than a height of the lens of the optical connector.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled.

As used in the description, the phrase “in an exemplary embodiment” and the like means that the described embodiment is just one example. The phrase is not intended to limit the inventive subject matter to that embodiment. Other embodiments of the inventive subject matter may not include the recited feature or structure. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. §112(f), unless and until such claim limitations expressly use the phrase “means for” followed by a statement of function void of further structure.

What is claimed is:

1. An optical connector comprising:
a ferrule body having a side face;
a transmission surface positioned along the side face, the transmission surface configured to align with a device surface of a communication device for communicating optical signals therebetween; and
a surface wiper coupled to and extending away from the side face, the surface wiper having a height relative to the side face, the surface wiper configured to at least one of flex or compress when engaging the device surface of the communication device during a side-mating operation.

2. The optical connector of claim 1, wherein the height of the surface wiper is at most four (4) millimeters.

3. The optical connector of claim 1, wherein the transmission surface is shaped to form a convex ferrule lens.

4. The optical connector of claim 3, wherein the height of the surface wiper is greater than a height of the ferrule lens.

5. The optical connector of claim 1, wherein the ferrule body is shaped to include the transmission surface, the optical signals propagating through the ferrule body during operation of the optical connector.

6. The optical connector of claim 1, further comprising an optical fiber having an end segment that is coupled to the ferrule body.

7. The optical connector of claim 4, wherein the optical fiber includes an angled end surface that is configured to reflect the optical signals in a predetermined direction that is generally transverse to the end segment of the optical fiber.

8. The optical connector of claim 4, wherein the transmission surface faces along a signal axis, the optical fiber extending parallel to the signal axis.

9. The optical connector of claim 1, wherein the surface wiper comprises a plurality of flexible strands that project away from the side face.

10. An optical arrangement comprising:
an optical connector comprising a ferrule body having a side face and a transmission surface that is positioned along the side face, the transmission surface facing in a first direction along a signal axis;
a communication device comprising an optical module having a side face and a transmission surface that is positioned along the side face of the optical module, the transmission surface of the communication device facing in a second direction along the signal axis that is opposite the first direction; and
a surface wiper coupled to the side face of the ferrule body or the side face of the optical module;
wherein the optical connector and the communication device are configured to mate with each other during a side-mating operation in which the side faces of the ferrule body and the optical module move parallel to each other along a mating axis that is perpendicular to the signal axis, the surface wiper configured to wipe the transmission surface of the opposing side face during the side-mating operation.

11. The optical arrangement of claim 10, wherein the surface wiper is a first surface wiper that is coupled to the side face of the optical connector, the optical arrangement further comprising a second surface wiper that is coupled to the side face of the communication device, wherein the first surface wiper is configured to wipe the transmission surface of the communication device and the second surface wiper is configured to wipe the transmission surface of the optical connector during the side-mating operation.

12. The optical arrangement of claim 11, wherein the first and second surface wipers and the transmission surfaces of the optical connector and the communication device are positioned relative to each other such that the first and second surface wipers concurrently engage the corresponding transmission surface during the side-mating operation.

13. The optical arrangement of claim 10, wherein the height of the surface wiper is at most four (4) millimeters with respect to the side face that the surface wiper is coupled to.

14. The optical arrangement of claim 10, wherein the ferrule body is shaped to include the transmission surface, the optical signals propagating through the ferrule body during operation of the optical connector.

15. The optical arrangement of claim 10, wherein the optical connector includes an optical fiber having an end segment that is coupled to the ferrule body.

16. The optical arrangement of claim 15, wherein the optical fiber includes an angled end surface that is configured to reflect the optical signals in a predetermined direction that is generally transverse to the segment of the optical fiber.

17. The optical arrangement of claim 15, wherein the optical fiber extends parallel to the signal axis.

18. The optical arrangement of claim 10, wherein the ferrule body has a leading side and a trailing side that face in opposite directions along a mating axis, the side face extending between the leading and trailing sides along the mating axis, the leading side configured to lead the optical connector during the side-mating operation.

19. The optical arrangement of claim 10, wherein the surface wiper comprises a plurality of flexible strands that project away from the corresponding side face, the surface wiper configured to at least one of flex or compress when engaging the corresponding transmission surface during the side-mating operation.

20. The optical arrangement of claim 10, wherein the transmission surface of the ferrule body is shaped to form a convex ferrule lens, the surface wiper being coupled to the side face of the optical connector and having a height relative to the side face of the optical connector that is greater than a height of the ferrule lens of the optical connector.
